(19) United States
(12) Patent Application Publication
(10) Pub. No.: US 2007/0097709 A1
(43) Pub. Date: May 3, 2007

(54) Liquid crystal display and backlight module having light guide plate integrally formed with point illuminator

(75) Inventor: Hsiang-Hui Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/592,861

(22) Filed: Nov. 2, 2006

(30) Foreign Application Priority Data
Nov. 2, 2005 (CN) 200510100963.X

(51) Int. Cl. F21V 7/04

(52) U.S. Cl. 362/620

(57) ABSTRACT

An exemplary backlight module (11) includes a light guide plate (13), and at least one point illuminator (14). The light guide plate includes a main body (130). The main body includes a bottom surface (132), and a diffraction grating structure (136) at a top of the main body. The at least one point illuminator is integrally formed in contact with the light guide plate without intervening space or substance therebetween except at a bottom of the at least one point illuminator. The bottom of the at least one point illuminator corresponds in position to the bottom surface.

### FIELD OF THE INVENTION

The present invention relates to backlight modules such as those used in liquid crystal displays (LCDs), and more particularly to a backlight module having a light guide plate integrally formed with a point illuminator.

### GENERAL BACKGROUND

Liquid crystal displays are commonly used as display devices for compact electronic apparatuses, because they not only provide good quality images but are also very thin. Because liquid in a liquid crystal display does not emit any light itself, the liquid crystal has to be lit by a light source so as to clearly and sharply display text and images. Therefore, liquid crystal displays typically require a backlight module.

Referring to FIG. 3, a typical backlight module 30 includes a diffusing film 32, a light guide plate (LGP) 34, and a reflective film 36, arranged in that order from top to bottom. The backlight module 30 further includes a light emitting diode (LED) 38 adjacent to a light incident surface 342 of the light guide plate 34. The light guide plate 34 further includes a bottom surface 344 perpendicularly connecting with the light incident surface 342, and a light emitting surface 346 opposite to the bottom surface 344. A plurality of dots 348 inwardly extend from the bottom surface 344. That is, the dots 348 are in the form of depressions.

The backlight module 30 employs the LED 38 as a light source. The LED 38 is recyclable and has low power consumption. Moreover, the dots 348 can reflect and diffuse light beams striking thereat, which can improve the uniformity of light emission of the backlight module 30. In a process of assembling the backlight module 30, a step of precisely aligning the LED 38 with the light incident surface 342 of the light guide plate 34 is needed. This step is problematic, and may lead to inefficiency and increased cost in manufacturing the backlight module 30. Further, light beams emitted from the LED 38 transmit into the light guide plate 34 through the light incident surface 342, and then propagate to the bottom surface 344 or the light emitting surface 346. The longer the propagation distance of the light beams, the lower the ratio of light utilization of the backlight module 30. That is, the backlight module 30 may be considered to have an unsatisfactory ratio of light utilization.

What is needed, therefore, is a backlight module that can overcome the above-described deficiencies. What is also needed is a liquid crystal display employing such a backlight module.

### SUMMARY

In one preferred embodiment, a backlight module includes a light guide plate, and at least one point illuminator. The light guide plate includes a main body. The main body includes a bottom surface, and a diffraction grating structure at a top of the main body. The at least one point illuminator is integrally formed in contact with the light guide plate without intervening space or substance therebetween except at a bottom of the at least one point illuminator. The bottom of the at least one point illuminator corresponds in position to the bottom surface.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, side cross-sectional view of a liquid crystal display according to an exemplary embodiment of the present invention, the liquid crystal display including a backlight module, the backlight module including a light guide plate.

FIG. 2 is a top plan view of the light guide plate of the backlight module of the liquid crystal display of FIG. 1.

FIG. 3 is an exploded, side cross-sectional view of a conventional backlight module.

### DETAILED DESCRIPTION OF PREFERRED EMBODIMENTS

Reference will now be made to the drawings to describe the preferred embodiments in detail.

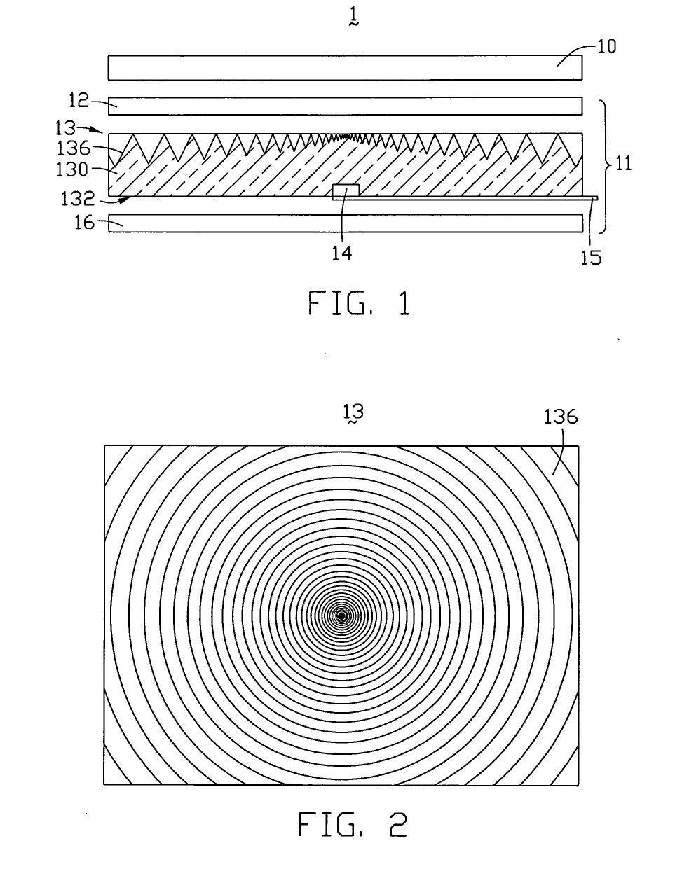

Referring to FIG. 1, a liquid crystal display 1 according to an exemplary embodiment of the present invention is shown. The liquid crystal display 1 includes a liquid crystal panel 10, and a backlight module 11 adjacent to an underside of the liquid crystal panel 10. The backlight module 11 includes a diffusing film 12, a light guide plate 13, a point illuminator 14, a flexible printed circuit (FPC) board 15, and a reflective film 16, arranged generally in that order from top to bottom.

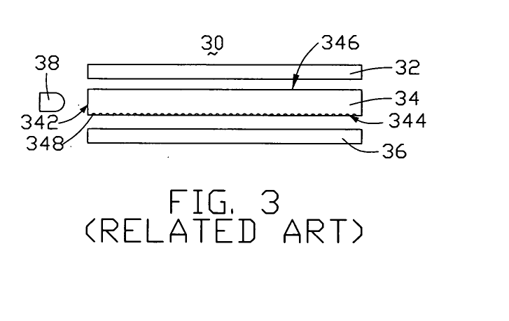

Referring also to FIG. 2, the light guide plate 13 includes a main body 130. The main body 130 includes a bottom surface 132. The reflective film 16 is positioned adjacent to the bottom surface 132. A plurality of prism structures 136 are formed at a top of the main body 130, opposite to the bottom surface 132. The diffusing film 12 is positioned adjacent to the prism structures 136. The prism structures 136 are annular and concentric, thus defining a center (not labeled) thereof. In the illustrated embodiment, the center defined by the prism structures 136 corresponds to a center of the bottom surface 132. A density of distribution of the prism structures 136 progressively increases away from the center of the prism structures 136. In particular, a distance between an acme (not labeled) of each prism structure 136 and a corresponding nearest acme (not labeled) of an adjacent prism structure 136 progressively increases away from the center of the prism structures 136. Further, a height of the prism structures 136 increases away from the center of the prism structures 136. That is, the acmes of the prism structures 136 all lie in a single common plane, with a depth of grooves between adjacent prism structures 136 increasing away from the center of the prism structures 136. Thus the prism structures 136 are arranged so that they form a so-called fresnel diffraction grating structure. The light guide plate 13 can be made from polycarbonate (PC) or polymethyl methacrylate (PMMA), and can be manufactured by an injection molding method.

In the illustrated embodiment, the point illuminator 14 is an LED 14. The LED 14 is integrally formed in the light guide plate 13 at the center of the bottom surface 132 of the main body 130. A bottom of the LED 14 is flush with the bottom surface 132. The FPC 15 is electrically connected with the LED 14, and abuts the bottom surface 132.

The light guide plate 13 integrally formed with the LED 14 can be made according to the following steps. First, the LED 14 is electrically connected with the FPC 15, and the LED 14 alone is placed in a mold. Second, the light guide plate 13 is formed in the mold by an injection molding method, with withal portions of the LED 14 except a bottom face thereof directly encased by the light guide plate 13.

In operation of the liquid crystal display 1, light beams emitted from the LED 14 propagate to the main body 130 directly, and are uniformly refracted or reflected by the prism structures 136. Some light beams emit from the light guide plate 13 through the prism structures 136, propagate to the diffusing film 12, and reach the liquid crystal panel 10 after being diffused by the diffusing film 12. Other light beams are reflected by the prism structures 136, and emit from the light guide plate 13 through the bottom surface 132, and propagate to the reflective film 16 adjacent the bottom surface 132. These light beams are then reflected back into the light guide plate 13 by the reflective film 16, and finally reach the liquid crystal panel 10 after being diffused by the diffusing film 12.

The light guide plate 13 includes the LED 14 integrally formed therein, and light beams from the LED 14 propagate to the prism structures 136 of the light guide plate 13 directly over relatively short distances. That is, compared to the above-described conventional light guide plate 34, propagation distances of the light beams are greatly reduced, thus obtaining an improved ratio of light utilization for the backlight module 11. Further, the prism structures 136 of the main body 130 form the so-called fresnel diffraction grating structure, whereby light beams passing therethrough are uniformly diffracted. This provides improved uniformity of light output by the backlight module 11, and improved performance for the liquid crystal display 1.

Further or alternative embodiments may include the following. In one example, two or more point illuminators can be provided at the bottom surface of the light guide plate. In such case, a physical center of distribution of the point illuminators corresponds to the center of the prism structures. In another example, the FPC can be replaced with a printed circuit board (PCB). In a still further example, side surfaces of the light guide plate between the top thereof and the bottom surface can be coated with a reflective material, for further improving a ratio of light utilization of the backlight module.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate comprising:
a main body comprising:
a bottom surface; and
a plurality of prism structures at a top of the main body; and
at least one point illuminator formed in immediate contact with the light guide plate, a bottom of the at least one point illuminator being substantially coplanar with the bottom surface.

2. The backlight module in claim 1, wherein the at least one point illuminator is at least one light emitting diode.

3. The backlight module in claim 1, wherein the prism structures are annular.

4. The backlight module in claim 3, wherein the prism structures are concentric.

5. The backlight module in claim 4, wherein a density of distribution of the prism structures increases away from a center thereof.

6. The backlight module in claim 4, wherein a height of the prism structures increases away from a center thereof.

7. The backlight module in claim 5, wherein the prism structures form a fresnel diffraction grating structure.

8. The backlight module in claim 4, wherein the at least one point illuminator is positioned corresponding to a center of the prism structures.

9. The backlight module in claim 1, wherein the light guide plate and the at least one point illuminator are injection molded in immediate contact with each other.

10. The backlight module in claim 1, further comprising a flexible printed circuit board electrically connected with the at least one point illuminator.

11. The backlight module in claim 10, wherein the flexible printed circuit board abuts the bottom surface of the main body of the light guide plate.

12. A backlight module comprising:
a light guide plate comprising:
a main body comprising:
a bottom surface; and
a diffraction grating structure at a top of the main body; and
at least one point illuminator integrally formed in contact with the light guide plate without intervening space or substance therebetween except at a bottom of the at least one point illuminator, the bottom of the at least one point illuminator corresponding in position to the bottom surface.

13. The backlight module in claim 12, wherein the at least one point illuminator is at least one light emitting diode.

14. The backlight module in claim 12, wherein the diffraction grating structure is a fresnel diffraction grating structure.

15. The backlight module in claim 12, wherein the at least one point illuminator is positioned corresponding to a center of the diffraction grating structure.

16. The backlight module in claim 12, wherein the light guide plate and the at least one point illuminator are injection molded in immediate contact with each other.

17. A liquid crystal display comprising:
a liquid crystal panel; and
a backlight module positioned adjacent to an underside of the liquid crystal panel, the backlight module comprising:
a light guide plate comprising:
a main body comprising:
a bottom surface; and
a fresnel diffraction grating structure at a top of the main body; and
at least one point illuminator located at the position which is vertical aligned with a center of the fresnel diffraction grating structure.

18. The liquid crystal display as claimed in claim 17, wherein said at least one point illuminator is integrally formed in contact with the light guide plate without intervening space or substance therebetween except at a bottom of the at least one point illuminator, the bottom of the at least one point illuminator corresponding in position to the bottom surface.
